(19) United States
(12) Patent Application Publication
(10) Pub. No.: US 2026/0160906 A1
(43) Pub. Date: Jun. 11, 2026

(54) SYSTEM AND METHOD FOR HIGH-FREQUENCY REMOTE SURVEYING

(71) Applicant: Barney F. Gorin, Gaithersburg, MD (US)

(72) Inventor: Barney F. Gorin, Gaithersburg, MD (US)

(21) Appl. No.: 19/179,590

(22) Filed: Apr. 15, 2025

Related U.S. Application Data
(60) Provisional application No. 63/634,124, filed on Apr. 15, 2024.

(51) Int. Cl. G01V 1/047; G01V 1/143; G01V 1/16

(52) U.S. Cl. CPC G01V 1/047; G01V 1/143; G01V 1/164; G01V 2210/70

(57) ABSTRACT

The present disclosure relates to a system and method for high-frequency remote surveying. The system includes a penetrometer with a mounting interface. The penetrometer further includes a housing with seismic wave generators configured to generate high-frequency seismic waves, sensors capable of detecting the high-frequency seismic waves, a control unit for controlling the seismic wave generators and processing sensor data, and a battery for powering housing components. The penetrometer can also include a penetrator configured to facilitate entry of the housing into a subsurface.

### CROSS-REFERENCE TO RELATED APPLICATION

This application is based upon and claims priority to Provisional Application No. 63/634,124 filed on Apr. 15, 2024, and Provisional Application No. 63/634,132 filed on Apr. 15, 2024, the entire content thereof is incorporated herein by reference in its entirety.

### FIELD OF THE INVENTION

This application is related to the field of remote surveying. In particular, the present invention relates to a system and method for large-scale high-frequency remote surveying of inhospitable or hazardous sites.

### BACKGROUND OF THE INVENTION

Remote sensing systems and methods have long been employed to investigate subsurface conditions in various environments. However, these existing technologies often fall short when faced with the challenge of detecting and identifying all types of objects, particularly in inhospitable or expansive areas. Understanding subsurface conditions in such places, whether it's a construction site on the Moon or a minefield on Earth, presents significant difficulties that can be both challenging and dangerous. The limitations of current methodologies become especially apparent when attempting to scale from small, manageable sites to vast, hazardous areas. For instance, techniques suitable for a construction site in Germany may prove entirely inadequate when applied to an extensive area like Zone Rouge in France.

Conventional remote sensing systems typically rely on lower frequency sensors due to their ability to penetrate deeper into the subsurface and their relative ease of implementation in field conditions. These lower frequency systems are well-suited for detecting larger objects or general subsurface structures over extensive areas. However, they have significant limitations when it comes to identifying smaller objects or providing high-resolution imaging of subsurface conditions. The wavelengths associated with lower frequencies are too large to interact meaningfully with small objects or fine details, resulting in a lack of precision in object detection and characterization. This shortcoming becomes particularly problematic in applications such as detecting unexploded ordnance or conducting detailed geological surveys, where the ability to identify and characterize small objects is crucial. Furthermore, the lower resolution of these systems can lead to ambiguities in data interpretation, potentially missing critical subsurface features or mischaracterizing detected objects. These limitations have long posed challenges for comprehensive and accurate subsurface surveying, especially in hazardous or inhospitable environments where detailed, high-resolution data is essential for safe and effective operations.

This inadequacy is particularly evident in the detection of Explosive Remnants of War (ERWs). Current methods for locating ERWs are not only slow and dangerous, putting human lives at risk, but also inefficient in covering large areas. Existing technologies typically create narrow, linear paths of examined territory rather than sweeping across expansive regions. Some systems even resort to intentionally detonating explosive devices to create narrow paths through minefields, sacrificing careful ordnance removal for expediency. These approaches highlight the pressing need for more advanced, comprehensive, and safer remote sensing solutions capable of addressing the challenges posed by diverse subsurface conditions and potentially hazardous objects across large-scale, inhospitable environments.

Accordingly, there is a need for a detailed remote surveying system that overcomes these and other challenges and is able to search an inhospitable site at scale, safely, economically, effectively, and efficiently.

### SUMMARY

Examples of the present disclosure provide systems and methods for high-frequency remote surveying.

According to a first aspect of the present disclosure, a penetrometer is provided. The penetrometer can include a mounting interface. The penetrometer can further include a housing. The housing can include a seismic wave generator configured to generate high-frequency seismic waves, sensors capable of detecting the high-frequency seismic waves and high precision location and time information, a control unit for controlling the seismic wave generator and processing sensor and location/time data, and a battery for powering housing components. The penetrometer can also include a penetrator configured to facilitate entry of the housing into a subsurface.

According to a second aspect of the present disclosure, a system for high-frequency remote surveying is provided. The system can include a local facility configured to map out an area for remote surveying. The system can further include at least one penetrometer. The at least one penetrometer can include a mounting interface, a housing, and a penetrator. The housing can include a seismic wave generator configured to generate high-frequency seismic waves, sensors capable of detecting the high-frequency seismic waves and high precision location and time information, a control unit for controlling the seismic wave generator and processing sensor data, and a battery for powering housing components. The penetrator can be configured to facilitate entry of the housing into a subsurface.

According to a third aspect of the present disclosure, a method for remote surveying is provided. The method may be implemented on a system for high-frequency remote surveying. The method may include receiving, at a mobile unit, a first location for a predetermined area to be surveyed. The method may further include placing, by the mobile unit, a first penetrometer at the first location. The method may also include activating, at the first penetrometer, a seismic wave generator configured to generate impact forces for driving the first penetrometer into a subsurface of the first location. The method may, in addition, include activating, at the first penetrometer, the seismic wave generator configured to generate high-frequency seismic waves. The method may also include receiving, at the first penetrometer, reflected high-frequency seismic waves. The method may further include transmitting high-frequency seismic wave data. The method may also include generating a survey report of the first location based on the high-frequency seismic wave data.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram of a system for high-frequency remote surveying, according to an example of the present disclosure.

FIG. 2 is a block diagram of a penetrometer, according to an example of the present disclosure.

FIG. 3A is a block diagram of a penetrometer, according to an example of the present disclosure.

FIG. 3B is a block diagram of a penetrometer, according to another example of the present disclosure.

FIG. 4A is a block diagram of a mounting interface for a penetrometer, according to an example of the present disclosure.

FIG. 4B is a block diagram of another mounting interface for a penetrometer, according to another example of the present disclosure.

FIG. 4C is a block diagram of another mounting interface for a penetrometer, according to another example of the present disclosure.

FIG. 5A is a block diagram of a penetrator interface for a penetrometer, according to an example of the present disclosure.

FIG. 5B is a block diagram of another penetrator interface for a penetrometer, according to another example of the present disclosure.

FIG. 5C is a block diagram of another penetrator interface for a penetrometer, according to another example of the present disclosure.

FIG. 6 is an illustration of a mobile vehicle for delivering penetrometers, according to an example of the present disclosure.

FIG. 7 is a seismic energy diagram, according to an example of the present disclosure.

FIG. 8 is a flow chart illustrating a method for remote surveying, according to an example of the present disclosure.

FIG. 9 is a block diagram of a computing system, according to an example of the present disclosure.

### DETAILED DESCRIPTION

While the present invention is capable of being embodied in various forms, for simplicity and illustrative purposes, the principles of the invention are described by referring to certain embodiments thereof. It is understood, however, that the present disclosure is to be considered as an exemplification of the claimed subject matter and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention. For example, while embodiments herein are described with reference to high-frequency remote surveying, it is understood that the systems and methods may be implemented similarly with respect to remote surveying more generally.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the terms “and” and “or” used herein is intended to signify and include any or all possible combinations of one or more of the associated listed items. As used herein, the term “if” may be understood to mean “when” or “upon” or “in response to a judgment” depending on the context.

The present disclosure relates to high-frequency remote surveying. In one or more embodiments, the high-frequency remote surveying system is used for large-scale surveying of hazardous sites. The system includes a network of advanced sensors, mobile units for sensor deployment, powerful computer systems for data processing and analysis, robust communication infrastructure, sophisticated software for navigation and data interpretation, and additional support equipment, all working in concert to enable comprehensive subsurface investigation and mapping. In one or more embodiments, the system is used for identifying Explosive Remnants of War (ERW), such as unexploded ordnance, land mines, or improvised explosive devices, which continue to pose significant dangers in post-conflict zones. For example, in areas like the Zone Rouge in France, where World War I left behind extensive contamination, this system can survey large tracts of land quickly and accurately, providing crucial information for safe land reclamation and development. This innovative approach addresses the critical need for safe, efficient, and comprehensive subsurface investigation in inhospitable environments. The system enables the detection, localization, and characterization of subsurface anomalies across vast areas without putting human lives at risk.

In one or more embodiments, the remote surveying system uses the penetrometers' on-board seismic sources, instrumentation, and computing power to calculate the local soil's seismic properties between each pair of penetrometers. By placing two penetrometers at known locations and with both having access to precise timing signals and commanding one to generate a seismic stimulus, the system can calculate the soil's seismic velocity and attenuation coefficient. The seismic wave velocity is critical to calculating the size of an anomaly detectable by a specific frequency. For example, if the seismic velocity is 200 meters per second and the frequency is 2,000 Hz, the smallest detectable anomaly would be 0.1 meters, or 10 centimeters, in any dimension. These properties also include the soil's seismic wave attenuation characteristics as a function of both distance and of frequency or dB-cm⁻¹-kHz⁻¹. The on-board system can calculate a maximum distance a detectable seismic wave of a particular frequency may travel using those attenuation characteristics with the seismic stimulus output power and the instrumentation sensitivity.

In one or more embodiments, the remote surveying system generates a map of the survey site showing penetrometer locations together with the calculated soil parameters between penetrometers, and as interpolated between calculated locations.

In one or more embodiments, the remote surveying system uses the map of the survey site to generate a penetrometer array configuration for maximum penetrometer spacing, or high productivity, while also meeting minimum size object detection goals within the limits of the local soil's seismic characteristics and penetrometer capabilities. This may be achieved through the “round trip” distance a wave must travel from the penetrometer to the object to the penetrometer or the “one way distance” from the penetrometer to the object to a second penetrometer.

In one or more embodiments, the remote surveying system continuously adjusts the penetrometer array configuration to accommodate new information. Potential anomalies might be designated for additional investigation by adding penetrometers to the array closer to the potential anomaly, for example.

In one or more embodiments, the remote surveying system utilizes seismic frequencies ranging from 1,000 Hz to 20,000 Hz. For instance, 2,000 Hz waves can be used over distances of approximately 5 meters, depending on soil conditions, seismic stimulus power, the instrument sensitivity, the seismic velocity, and the attenuation of the seismic wave over distance. This frequency provides acceptable readings for detecting anomalies while balancing penetration depth and resolution. The effective distance for a given frequency depends on the local soil's seismic velocity and attenuation characteristics, which can be measured using two penetrometers. By placing two penetrometers at known locations and having one generate a seismic stimulus, the system can calculate the soil's seismic velocity and attenuation coefficient. These parameters are used for optimizing penetrometer spacing and interpreting the received signals.

For higher frequency sensing, the system employs more sophisticated techniques. This involves using a high-power, directional seismic source in one penetrometer, aimed towards another. Unlike the broadband energy produced by a hammer impact, this source concentrates energy at a single frequency, similar to a loudspeaker but for seismic waves. This approach allows for higher resolution imaging but over shorter distances. The system dynamically adjusts penetrometer locations based on the expected size of potential threats and the desired survey productivity.

The precise timing and location data from each penetrometer, combined with advanced edge processing capabilities, enable the calculation of several critical parameters. These include the time-of-flight of seismic waves between penetrometers, which is used to compute soil velocity; the amplitude decay of waves over distance, used to determine the attenuation coefficient; and the precise location and characteristics of subsurface anomalies. For example, if a seismic wave takes 10 milliseconds to travel between two penetrometers spaced 2 meters apart, the system can calculate a nominal soil velocity of 200 m/s which would include some uncertainty for the first calculation. Additional measurements would quickly resolve the soil velocity to a precise value. Actual soil seismic velocities are expected to fall within a general range from 100 to 250 m/s.

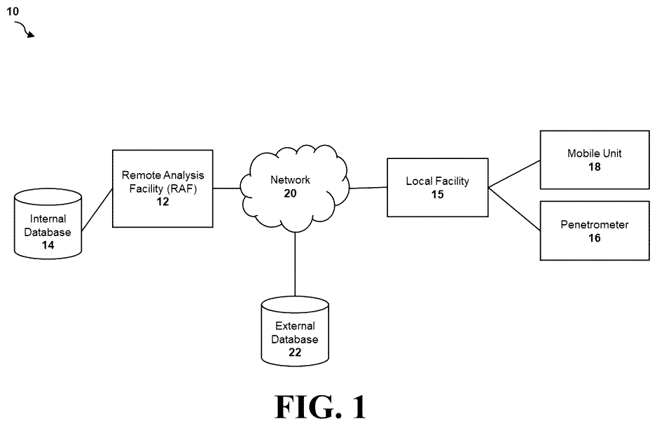

Turning now to the figures, FIG. 1 shows a remote surveying system 10, according to an embodiment of the present disclosure. The remote surveying system 10 includes a remote analysis facility (RAF) 12 with an internal database 14, local facility 15, at least one penetrometer 16, a mobile unit 18, a network 20, and an external database 22. The RAF 12 is able to communicate with the local facility 15 and external database 22 through the network 20. The local facility 15 can communicate with the penetrometer 16 and mobile unit 18 through wireless communication or a local wireless network. The RAF 12 can be a remote central analysis and control system or part of a cloud platform that runs software for extended analysis of the surveying data.

The local facility 15 serves as an on-site operational hub for the remote surveying system 10. Located in proximity to the area being surveyed, it acts as an intermediary between the RAF 12 and the field equipment, including the penetrometers 16 and mobile units 18. The local facility 15 is equipped with local computing power such as a high-performance server or small cluster of computers capable of near real-time data processing, temporary data storage, and running complex algorithms for initial data analysis. The computing resources at the local facility enable it to perform tasks such as data compression, noise filtering, and preliminary anomaly detection, reducing the amount of raw data that needs to be transmitted to the RAF 12. This local processing capability also allows for rapid decision-making in response to field conditions, such as adjusting penetrometer placement or mobile unit paths based on initial and ongoing findings. The local facility 15 further includes communication systems that allow it to receive instructions from the RAF 12 via the network 20 and relay these commands to the field equipment using wireless communication or a local wireless network. It also collects and preprocesses data from the penetrometers 16 and mobile units 18 before transmitting it back to the RAF 12 for comprehensive analysis. This local facility can house maintenance equipment, spare parts, and potentially a team of technicians to manage and service the field equipment, ensuring continuous and efficient operation of the surveying system. By having this local presence, the system can respond quickly to changing conditions without requiring constant direct communication between the field equipment and the distant RAF 12.

The RAF 12 is an operational hub of the remote surveying system, integrating advanced data processing capabilities with human oversight functions. Located in a secure facility away from hazardous survey areas, the RAF houses powerful computing resources, sophisticated analysis software, and operator workstations. It receives raw and processed data from the field deployed penetrometers and further processes that data, utilizing processes and algorithms to detect, characterize, and precisely locate subsurface objects. The RAF coordinates the overall survey strategy. By combining automated analysis with human decision-making capabilities, the RAF enables efficient, safe, and accurate subsurface surveying across large areas, while maintaining the flexibility to adapt to complex scenarios that require human judgment. The RAF communicates with an internal database 14 that stores and manages vast amounts of data gathered from penetrometers, survey area characteristics, outside sources such as combat records or unit histories, detailed descriptions of various types of ordnance and landmines, satellites, and operational parameters. This database not only archives raw sensor data but also supports the system's processing algorithms, storing intermediate results, and analysis outputs. By leveraging this comprehensive data repository, the RAF can perform real-time analysis, historical comparisons, and predictive modeling to enhance the accuracy and efficiency of the survey process.

The penetrometer 16 is a sophisticated sensing device that serves as the primary data collection tool in the remote surveying system 10. Designed for insertion into the ground at predetermined locations across the survey area, the penetrometer combines multiple functions in a single, modular unit. It includes a dynamic penetration mechanism, featuring an internal recoilless hammer that drives the device into the soil while simultaneously generating seismic waves. The penetrometer is equipped with an array of high-sensitivity sensors, including accelerometers, geophones, and microphones, capable of detecting seismic frequencies ranging from 1,000 Hz to 10,000 Hz. This would allow for the detection and characterization of very small objects. As it penetrates the ground, the device continuously measures soil resistance and captures reflected seismic waves from subsurface objects or layers. The penetrometer also incorporates precise location, time, and orientation sensors, ensuring accurate geospatial data for each measurement. All collected data is transmitted in real-time to the Local Facility and RAF through, for example, a mesh network communication system, enabling immediate processing and analysis. The network also allows penetrometer-to-penetrometer communication for coordinated measurements of the local soil's seismic velocity and attenuation characteristics to facilitate optimal penetrometer installation, operation, removal, and reuse. This innovative design makes the penetrometer an essential tool for efficient, safe, and accurate subsurface surveying, particularly in hazardous areas.

The mobile unit 18 is designed to transport and deploy penetrometers across the survey area with minimal human intervention. The mobile unit 18 can include an Uncrewed Ground Vehicle (UGV), an Uncrewed Aerial Vehicle (UAV), or an Uncrewed Water Vehicle (UWV), which serves as a versatile and autonomous platform for penetrometer placement operations. This mobile unit 18 is equipped with advanced navigation systems, including GPS and obstacle detection sensors, allowing it to traverse challenging terrains safely and efficiently. The mobile unit 18 features a specialized payload system for storing multiple penetrometers and a mechanism for precise penetrometer deployment.

The external database 22 is a versatile and scalable component of the remote surveying system, designed to augment the capabilities of the RAF. This database can be implemented as a dedicated server or a cloud computing platform, providing additional storage capacity to support the surveying operations. It serves as a centralized repository for a wide range of data relevant to the survey area, including historical and geological information, satellite imagery, previous survey results, and known hazard locations. The external database can also host specialized algorithms or machine learning models that may require more extensive computational resources than available in the field-deployed local facility. By leveraging cloud computing capabilities, the system can perform complex analyses, run simulations, or process large datasets without impacting the real-time operations at the local facility. Additionally, the external database facilitates data sharing and collaboration with other agencies or research institutions, allowing for the integration of diverse data sources to enhance the accuracy and comprehensiveness of the subsurface surveys. This external resource significantly expands the system's analytical capabilities and flexibility, enabling more informed decision-making and improved survey outcomes.

In an embodiment, the remote surveying system 10 operates by first deploying an uncrewed ground vehicle 18 to strategically place high-frequency sensors 16 across a survey area. Initial readings are then taken and analyzed by the penetrometer edge processor(s) to identify areas of interest or potential anomalies. Based on this analysis, additional sensors 16 are precisely positioned to further investigate specific objects or regions, allowing for detailed mapping and characterization of subsurface conditions through iterative surveying and data fusion.

In one or more embodiments, the Local Facility 15 is the brain of the site examination automation process and allows for high level of automation that makes the remote surveying system safe, effective, and economical. The local facility's operational cycle includes (1) a detailed map of the area to be surveyed; (2) a “first cut” set of penetrometer locations based on the map data; (3) the penetrometer locations are used to calculate a penetrometer installation cycle beginning with the first penetrometer to be installed; (4) the penetrometer installation cycle is used to calculate a path plan for the equipment bringing the penetrometers to their installation locations; (5) the seismic data from all penetrometers, and beginning with the first one, is used to verify that the path to and installation of the next penetrometer in the plan is within site safety rules. The system uses seismic data from installed penetrometers to verify safety for deploying the next one. It checks both the path to the installation site and the site itself against predefined safety rules. This process is repeated for each new penetrometer, ensuring continuous safety assessment throughout the deployment based on real-time seismic data; (6) if a potential safety hazard is identified that would endanger the penetrometer placement equipment, the local facility software replans the equipment's route for both safety and for close inspection of the possible safety hazard; (7) the baseline for close inspection is for the local facility to calculate the locations for added penetrometers placed sequentially closer to the possible safety hazard; (8) the remote analysis computers use this combination of close inspection, data from high-frequency seismic instrumentation in the instrumented penetrometer, and multiple sensor locations around the suspected safety hazard to calculate a 3-dimensional, or 3-D, image of the suspected safety hazard that is akin to an ultrasound image; (9) close inspection can also be accomplished by using other sensors, such as a ground penetrating radar (GPR) on a specialized uncrewed vehicle, but the detailed analysis of the data remains at the remote analysis facility and the general process of developing a 3-D image remains the same; (10) the remote analysis system then compares the 3-D image of the suspected safety hazard with 3-D solid models of safety hazards of similar size to both characterize and precisely geolocate it; (11) the remote analysis system then classifies the identified potential safety hazard as either non-hazardous or potentially hazardous and requiring intervention by technicians or other personnel; (12) the full analysis of the potential safety hazard is provided to the technicians assigned to remediate or mitigate the hazard; (13) the technicians then report their findings for recording on the system for later processing.

In an embodiment, a detailed map is obtained from outside sources and downloaded through the RAF. In another embodiment, when no sufficient map is available a map can be created, for example, by an UAV equipped with a suitable camera combined with photogrammetry software in the local facility. The map can then be uploaded to the RAF.

In an embodiment, the RAF can be configured to analyze the penetrometer data by combining it with other information such as notes or maps. The RAF may use the results of this data fusion process to develop higher value analysis results such as the most likely artifact type to exist within a given subsurface anomaly by matching those results with computer models, photographs, or detailed descriptions of the ordnance likely to have been used during combat at the site. This information may make the process of eliminating the threat posed by the subsurface artifact safer and less time consuming.

In an embodiment, the remote surveying system includes a human control center that serves as the central hub where operators monitor automated equipment and respond to off-nominal situations. Its staffing level correlates with the number of operational sites and site-specific hazards. This center can be situated anywhere with appropriate office space, utilities, and internet connectivity, offering flexibility in its location.

In an embodiment, the local facility is strategically positioned away from hazardous inspection areas. It functions as a maintenance and support base for the uncrewed vehicles and instrumented penetrometers, housing a well-equipped shop area and maintaining a substantial inventory of parts and supplies.

In an embodiment, the local facility can do “site level” computing: edge in the penetrometer, “Site Level or Fog Layer” in the local facility, the heavy duty computational load of understanding what the threats are in the Remote Analysis Facility. Together, these facilities ensure efficient, safe, and well-supported operations for the remote surveying system across various deployment scenarios. The RAF can control as many sites as needed. It can share new knowledge across sites as soon as it is created. More sites worldwide can include more workstations, and possibly virtual machines, in the RAF.

In an embodiment, the remote surveying system employs a hierarchical processing structure to efficiently manage data collection, analysis, and decision-making. This structure consists of three primary layers: edge processing, local processing (fog layer), and the Remote Analysis Facility (RAF) or cloud layer.

At the ground level, mobile vehicles (ground, air, and water-based) equipped with various sensors and edge computing capabilities navigate the survey area, detect potential threats, and deploy penetrometers. These vehicles continuously transmit their situational awareness data to the local facility. The penetrometers, featuring internal hammers and potentially other noise-generating mechanisms (akin to loudspeakers), conduct seismic surveys and perform initial data processing. Their edge computing power allows for real-time measurement of local soil characteristics and preliminary threat detection, with this processed data being sent to the local facility.

The local facility, positioned as an intermediary between the field equipment (mobile vehicles and penetrometers) and the RAF, serves as the system's fog layer. This facility houses significant computing resources to perform data fusion from all penetrometers, enabling more comprehensive threat identification. It also manages the deployment strategy for the penetrometer array, determining optimal placement for new units and identifying when existing penetrometers should be retrieved for redeployment. This local processing is used for maintaining the efficiency and effectiveness of the ongoing survey operation.

In one or more embodiments, the RAF can be configured to analyze the penetrometer data by combining it with other information sources. These sources may include combat records and unit histories, which provide context about the types of military activities that occurred in the surveyed area. The system also incorporates detailed descriptions of various types of ordnance and landmines, allowing for more accurate identification of detected objects. Satellite imagery can be used to correlate subsurface findings with surface features or historical changes in the landscape. Operational parameters from past and current surveying missions are also considered to refine the analysis process. The RAF may use the results of this data fusion process to develop higher value analysis results, such as determining the most likely artifact type to exist within a given subsurface anomaly by matching those results with computer models, photographs, or detailed descriptions of the ordnance likely to have been used during combat at the site. This comprehensive approach to data analysis enhances the system's ability to accurately identify and characterize potential threats, making the process of eliminating the threat posed by the subsurface artifact safer and less time consuming.

In one or more embodiments, each penetrometer is equipped with multiple sensors arranged in different orientations or positions within the housing. This configuration allows a single penetrometer to detect the direction from which seismic waves are received, enhancing its ability to contribute to precise localization of subsurface anomalies.

### High-Frequency Surveying

In one or more embodiments, the system utilizes penetrometers capable of detecting frequencies much higher than traditional seismic equipment, potentially up to 60,000 Hz, which allows for the detection and characterization of smaller objects and finer subsurface features. Unlike traditional geophones that may operate at frequencies 1 to 5 Hz, this system incorporates sensors capable of detecting seismic waves at frequencies as high as 60,000 Hz. This dramatic increase in frequency range allows for the detection and characterization of much smaller subsurface objects-down to 3 millimeters in size, compared to the meter scale of conventional systems. The higher frequencies provide significantly improved resolution, analogous to the difference between low and high-resolution imaging in other fields. This enhanced capability is achieved through a combination of highly sensitive sensors, continuous calculation of the local soil characteristics, advanced signal processing techniques, precise placement for each individual penetrometer based on soil characteristics and selected threat size limits, and the strategic sensor placement within the penetrometer. The system's ability to both generate and detect high-frequency seismic waves enables the RAF to create detailed, three-dimensional subsurface images, analogous to medical ultrasound technology. This high-frequency approach, coupled with the penetrometer's unique design for in-situ soil measurements, allows for unprecedented accuracy in identifying and characterizing small subsurface anomalies or artifacts, making it particularly valuable for applications such as unexploded ordnance detection or precise geological surveys in challenging environments. The artifacts can include items ranging from hand grenades to 250 lb bombs to sewer pipelines.

### Penetrometers

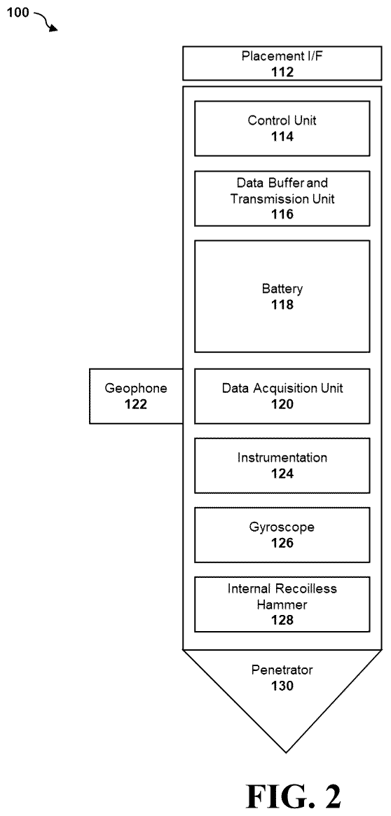

FIG. 2 shows a penetrometer 100, according to an embodiment of the present disclosure. The penetrometer 100 includes a placement interface 112, control unit 114, data buffer and transmission unit 116, battery 118, data acquisition unit 120, geophone 122, instrumentation 124, gyroscope 125, internal recoilless hammer 128, and penetrator 130. The placement interface 112 allows for easy handling and deployment by uncrewed vehicles or other placement systems. The control unit 114 provides edge computing and coordinates operations and communications within the penetrometer. This unit manages system initialization, sensor operations, data preprocessing, power management, and communication protocols. It interfaces with the data acquisition unit 120, which collects readings from the geophone 122, instrumentation 124, and gyroscope 125. These sensors provide crucial data on seismic waves, orientation, and subsurface soil characteristics. The penetrometer will also get data from a Global Navigational Satellite System (GNSS) [GPS is a part of that] with Real Time Kinematic (RTK) correction. This is where the precise location and time signals come from.

The internal recoilless hammer 128 serves a dual purpose: it drives the penetrometer into the ground during installation and generates seismic waves for surveying. The penetrator 130 is the physical interface with the soil, designed for optimal penetration and seismic wave transmission. The gyroscope 125 ensures the penetrometer maintains proper orientation during installation. All collected data is temporarily stored in the data buffer and transmission unit 116 before being sent to the local facility for processing and upload to the RAF.

The battery 118 powers all onboard systems, with its usage optimized by the control unit 114. The placement interface 112 is designed for compatibility with mobile unit or other deployment systems, facilitating easy handling and precise positioning. All these components work in concert, communicating through internal protocols managed by the control unit 114. The penetrometer operates as part of a larger network, sending data to and receiving commands from the local facility, which coordinates the overall survey operation. This integrated approach allows for adaptive, real-time surveying strategies based on the data collected and analyzed across multiple penetrometers in the field.

In one or more embodiments, the seismic energy is generated using recoilless hammers and/or noisemakers (such as a loudspeakers) that are oriented horizontally and can be commanded to operate at specific frequencies.

In one or more embodiments, the penetrometer combines seismic source and sensor capabilities in a single unit, featuring multiple high-frequency sensors capable of detecting up to 60,000 Hz, far exceeding conventional 1 to 5 Hz geophones. Its dynamic design allows for self-installation using an internal recoilless hammer positioned at the penetrator tip, with gyroscopic stabilization ensuring vertical alignment. This configuration enables precise seismic impacts while minimizing shock to other components. The device can also be installed conventionally using an external hammer if needed.

The penetrometer's versatility extends beyond installation, as it can generate seismic waves post-installation and incorporates high-precision location and time instrumentation. Its modular design adapts to various site conditions and accommodates different placement systems. On-board electronics handle data acquisition and conversion, while mesh network capabilities enable remote command reception and data transmission. A magnetic interface facilitates efficient handling by uncrewed vehicles, enhancing overall system productivity and flexibility in deployment scenarios.

The data acquisition unit 120 interfaces directly with the sensors, including the geophone 122, which detects seismic waves, and internal instrumentation 124 such as Global Navigation Satellite System (GNSS) for precise geographic location and time, angle sensors, accelerometers and microphones for high-frequency detection.

A gyroscope 126 maintains the penetrometer's vertical orientation during installation and operation. The internal recoilless hammer 128 serves a dual purpose: it drives the penetrometer into the ground and generates seismic waves for subsurface analysis. Finally, the penetrator 130 at the base of the device is designed to efficiently enter the soil while housing sensors for direct contact with the subsurface environment.

In an embodiment, the integrated system allows the penetrometer to simultaneously install itself, generate seismic waves, collect high-resolution data about the subsurface, and transmit this information for immediate analysis, making it a powerful tool for comprehensive and efficient subsurface surveys.

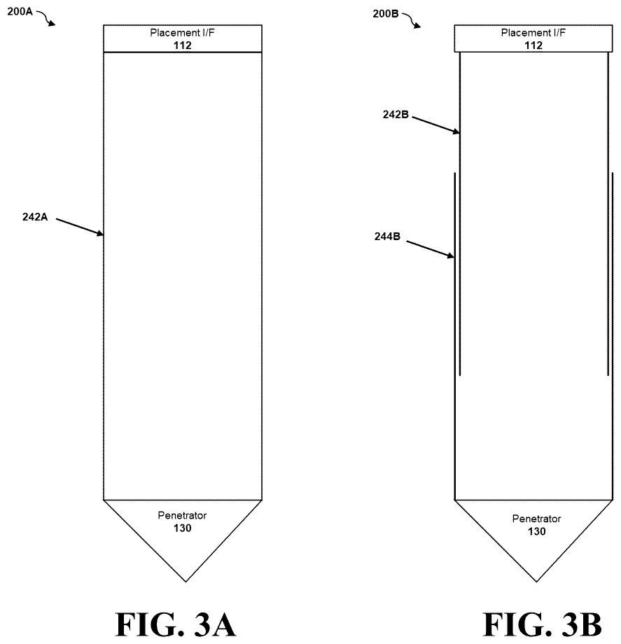

FIGS. 3A and 3B show penetrometers 200A, 200B, according to embodiments of the present disclosure. The penetrometer 200A can include a body 242A that is solid. The penetrometer 200B can also be an extendable body with walls 242B and 244B. In FIG. 3A, the penetrometer 200A features a solid body 242A, offering enhanced structural integrity, improved resistance to impact forces during installation, and better protection for internal components against harsh environmental conditions. This solid design may provide superior heat dissipation and simplified manufacturing but could limit adaptability to uncrewed vehicle penetrometer handling systems' kinematic limitations. In FIG. 3B, the penetrometer 200B utilizes an extendable body with walls 242B and 244B, employing a telescoping mechanism. This design allows for adjustable length, accommodating various uncrewed vehicle kinematic needs and soil depths and conditions, while also enabling compact storage and transportation when retracted. The extendable configuration offers greater flexibility in deployment scenarios, especially in confined spaces, and potentially allows for reaching greater depths than a fixed-length design.

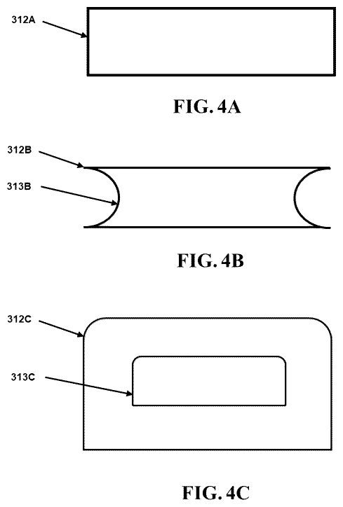

FIGS. 4A, 4B, and 4C shows various placement interface designs (312A, 312B, 312C) for penetrometers according to embodiments of the present disclosure. These interfaces are engineered to facilitate efficient and secure handling by robotic arms or other mechanical placement devices. In FIG. 4A, the placement interface 312A features a solid, flat surface compatible with suction devices or magnetic plates, offering a simple yet effective connection method. FIG. 4B showcases placement interface 312B with curved sections 313B, specifically designed to accommodate gripping components for secure attachment to placement mechanisms. FIG. 4C presents a more intricate design in placement interface 312C, incorporating a central void 313C that allows for easy handling by human beings. Each of these designs is tailored to optimize the interaction between the penetrometer and its deployment system, ensuring precise positioning and efficient installation across various operational scenarios and environments.

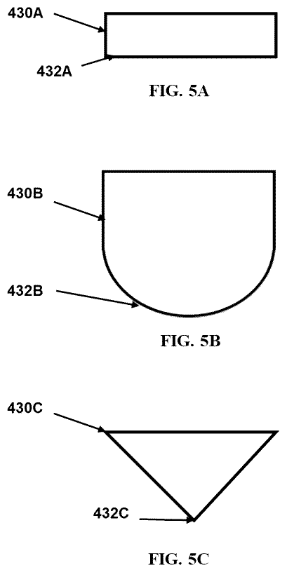

FIGS. 5A, 5B, and 5C illustrate three distinct penetrator interface designs (430A, 430B, 430C) for the penetrometer system, each tailored to specific soil conditions and penetration requirements. The flat structure 430A features a flat end 432A, suitable for softer soils where increased resistance to installation is desired for added seismic energy generation. The round tip structure 430B with its curved end 432B offers customized penetration resistance for a variety of soil types. The conical tip structure 430C, ending in a pointed tip 432C, is designed for maximum penetration capability, particularly effective in harder or more compact soil conditions. These varied designs enable the penetrometer system to adapt to diverse geological environments, optimizing its effectiveness across different deployment scenarios.

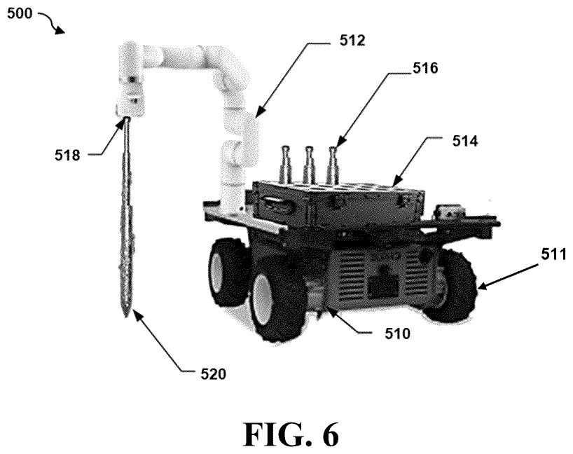

FIG. 6 shows a mobile unit 500 according to an embodiment of the present disclosure. The mobile unit 500 is an uncrewed ground vehicle with a motor 510, tires 511, an arm 512, a quiver 514, a first penetrometer 516, an engage unit 518, and a second penetrometer 520. The motor 510 is used to power tires 511 for traveling through ground terrain. The quiver 514 is a container designed to hold multiple penetrometers while the mobile unit 500 travels to place the penetrometer. The quiver 514 is also designed to allow the penetrometer to be accessed and removed for placing the penetrometer on the ground but also for accepting the penetrometer when picked up by the mobile unit 500. The first penetrometer 516 is located in the quiver 514 and can be removed for surveying. The engage unit 518 is designed to connect the penetrometer to the arm for placing and releasing the penetrometer whether on the ground or back in the quiver 514. The engage unit 518 can be a gripping mechanism, magnetic mechanism, air pressure mechanism, or other mechanism for connecting to and moving the penetrometer. The second penetrometer 520 is connected to the engage unit 518 and can be placed in the ground or into the quiver 514.

In one or more embodiments, the mobile unit 500 includes a diverse range of uncrewed vehicles (ground, water, and air) for installing instrumented penetrometers, maximizing efficiency through full automation. The mobile unit 500 can significantly reduce inspection costs, eliminate human exposure to hazardous objects, and enable exploration of remote sites, including lunar locations. Ground vehicles (wheeled, tracked, or legged) are selected based on site conditions, with wheeled options preferred for productivity and cost-effectiveness. Water vehicles, designed for shallow operations, serve in swampy or marshy areas. Air vehicles, typically handling one penetrometer at a time via electromagnet, offer precise placement capabilities and access to locations that may be inaccessible to ground vehicles and locations with only a small area to be searched. Human involvement is limited to logistical tasks such as unpacking, initialization, loading, maintenance, and repacking of penetrometers, ensuring a balance between automation and necessary manual oversight.

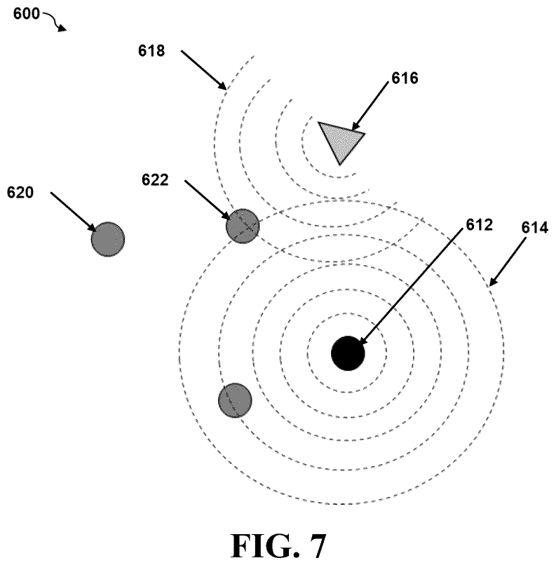

FIG. 7 shows a hammer-generated seismic energy map 600, according to an embodiment of the present disclosure. The map includes a penetrometer 612, seismic waves 614, subsurface anomaly 616, reflected seismic waves 618, previously emplaced penetrometer 620, and primary penetrometer 622. The penetrometer 612 generates seismic waves 614 that propagate through the surrounding medium. These waves interact with a subsurface anomaly 616, producing reflected and refracted seismic waves 618 that are detected by both the originating penetrometer 612 and a previously emplaced penetrometer 620. The primary penetrometer 622 is able to read the reflected seismic energy and can serve as a reference point. This visualization demonstrates the system's ability to use multiple penetrometers in concert to detect and characterize subsurface features, leveraging direct, refracted, and reflected seismic waves for comprehensive underground mapping.

The local facility will use the local soil's seismic speed and attenuation characteristics to balance penetrometer spacing between finding small objects with closely spaced penetrometers or higher productivity that only finds larger objects with wider penetrometer spacing. By installing the penetrometers a significant distance apart (e.g., 25 meters), and using the hammer-induced and reflected seismic energy to locate subsurface anomalies, embodiments of the present disclosure can cover large areas quickly. For example, if a single UGV can install one penetrometer every 10 minutes, it can install approximately 49 penetrometers in an 8-hour shift. If the penetrometers are placed in a 7 by 7 matrix and spaced 25 meters apart, the included area would be 150 by 150-meters or 22,500 square meters. If the sensible area extends 12.5-meters beyond the edge of the included area, then the sensed area becomes 175 by 175-meters or 30,625 square meters. At that rate of inspection, a single system consisting of one local facility and five UGVs could inspect a site measuring one square kilometer in less than seven working shifts, or less than three days with operators relieved every 8 hours.

The system concept's scalability, the fact that a single local facility combined with a highly capable control station can control many relatively inexpensive UGVs, allows the system to expand as needed to address very large areas that may harbor hazardous objects. The merging of advanced robot management tools, e.g., algorithms for swarm path planning and replanning, to enhance the capabilities of the autonomous UGV robots decreases the operator-to-robot ratio and minimizes human operator labor. The system's use of retrievable and reusable penetrometers, i.e., those that are too far from the seismic stimulus to sense even the primary seismic energy or that no longer have sufficient battery power to function, reduces recurring costs.

The process begins with the penetrometers being inserted into the ground by uncrewed ground vehicles. These penetrometers serve a dual purpose: they act as both seismic sources and sensors. When a penetrometer is hammered into the ground, it generates high-frequency seismic waves that propagate through the surrounding soil. The seismic source elements in each penetrometer also produce seismic stimulus in focused directions and at specific frequencies. These waves interact with subsurface objects and structures, reflecting and refracting based on the properties of the materials they encounter.

The reflected/refracted high-frequency waves are then detected by the network of penetrometers deployed across the survey area. Each penetrometer is equipped with multiple types of sensors, including geophones, microphones, and accelerometers, all capable of detecting these high-frequency signals. The use of multiple sensor types and their strategic placement in various directions and at various depths allows for the capture of a rich dataset that includes information from different angles and perspectives.

The high-frequency nature of these waves provides several advantages. Firstly, it allows for better resolution of small objects and fine details in the subsurface, as the shorter wavelengths can interact with smaller features. Secondly, it enables more precise determination of object boundaries and characteristics. However, high-frequency waves also attenuate more rapidly in soil, which is why the system uses a dense network of sensors to ensure adequate coverage and signal strength.

The data collected from this network of high-frequency sensors is then transmitted to powerful computer systems for processing and analysis. Processing at the local facility identifies small potential threats using data fusion techniques to merge the data from multiple penetrometers. Advanced algorithms in the RAF fuse the data from multiple sensors and sensor types and use artificial intelligence and machine learning to create detailed 3D images of the subsurface. These images can reveal the presence, size, shape, and depth of buried objects with a level of detail not achievable with lower-frequency systems.

By leveraging the properties of high-frequency seismic waves and combining them with advanced sensing and data processing techniques, this system pushes the boundaries of what's possible in remote subsurface surveying, offering unprecedented insight into underground conditions across large areas.

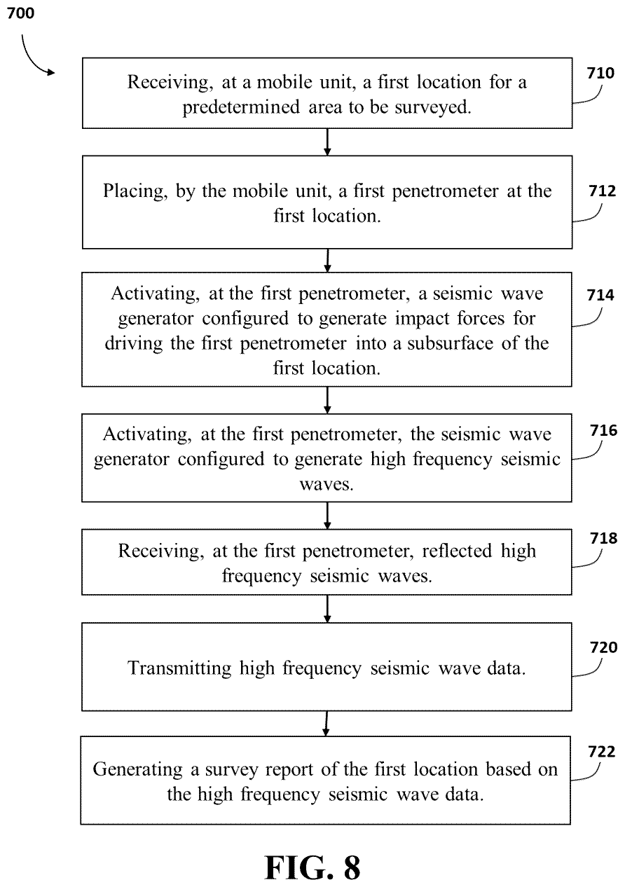

FIG. 8 shows an example method for remote surveying in accordance with the present disclosure. The method can be applied to a system for high-frequency remote surveying that includes a computing system, or platform, having one or more component servers or computers.

In step 710, the remote surveying system recevies, at a mobile unit, a first location for a predetermined area to be surveyed. The location can be determined by the local facility or at the RAF by analyzing a map of the area to be surveyed. The location information can include GPS coordinates, distance sensors, or triangulation technology for determining and finding the first location by the mobile unit.

In step 712, the remote surveying system places, by the mobile unit, a first penetrometer at the first location. The mobile unit can be an unmaned ground vehicle that carries at least one penetrometer and can travel to the first location and place the penetrometer in the surface to be surveyed.

In step 714, the remote surveying system activates, at the first penetrometer, a seismic wave generator configured to generate impact forces for driving the first penetrometer into a subsurface of the first location. The penetrometer uses a self-driving process for moving into the subsurface at the first location. This sophisticated mechanism employs an internal recoilless hammer to generate impact forces, propelling the penetrometer to a predetermined depth. The process is guided by real-time feedback from the penetrometer's integrated instrumentation, which monitors the seismic waves produced during insertion. This self-driving capability ensures precise depth control and optimal positioning for subsequent seismic data collection, while also serving the dual purpose of generating initial seismic waves for subsurface analysis. The system's ability to autonomously adjust its insertion based on the subsurface conditions encountered demonstrates its advanced adaptability and efficiency in various geological settings.

In step 716, the remote surveying system activates, at the first penetrometer, the seismic wave generator configured to generate high-frequency seismic waves. Once securely installed in the subsurface, the penetrometer employs its seismic wave generating capability, including its internal recoilless hammer, to produce seismic waves.

In step 718, the remote surveying system receives, at the first penetrometer, reflected high-frequency seismic waves. These waves, originally generated by the penetrometers internal recoilless hammer, have propagated through the subsurface and reflected off various geological features and potential anomalies. The penetrometer's sensitive seismic sensors, including microphones, accelerometers, and geophones, capture these reflected waves with high precision. This reception process is crucial for building a detailed subsurface profile, as the characteristics of the reflected waves-including their amplitude, frequency, and arrival time-contain valuable information about the composition, structure, and potential anomalies in the surveyed area. The ability to both generate and receive high-frequency seismic waves from the same device enhances the system's efficiency and data quality, enabling more accurate subsurface mapping and anomaly detection.

In step 720, the remote surveying system transmitts high-frequency seismic wave data. This transmission includes both the original wave characteristics and the received reflected wave data, providing a comprehensive dataset for advanced analysis. The data is sent via a secure, high-bandwidth communication link to ensure rapid and reliable transfer. In an embodiment, the data is sent to the local facility, which leverages powerful computing resources and sophisticated algorithms to interpret the seismic data, potentially employing algorithms for anomaly detection, subsurface mapping, and characterization. This approach allows for real-time or near-real-time analysis, enabling quick decision-making and adaptive survey strategies based on the processed results, while also reducing the computational burden on the individual penetrometers in the field.

In step 722, the remote surveying system generates a survey report of the first location based on the high-frequency seismic wave data. This report synthesizes the complex seismic data into actionable intelligence, likely including detailed subsurface maps, identified anomalies, and characterizations of geological features. Advanced algorithms, possibly incorporating artificial intelligence and machine learning techniques, analyze the seismic wave patterns, reflections, and refractions to construct a three-dimensional model of the subsurface. The report may include visualizations such as cross-sectional views, depth maps, and anomaly highlights, along with quantitative data on local seismic velocity and attenuation characteristics, soil density, layer thicknesses, and potential hazards like unexploded ordnance or voids. This detailed analysis provides crucial information for decision-makers, enabling informed choices about further investigations, safety assessments, or construction planning based on the surveyed site's subsurface conditions.

In an embodiment, when a penetrometer detects an object of interest, the local facility or RAF can determine that additional, more detailed scans are required. The local facility or RAF analyzes the initial seismic data and calculates an optimal new location for closer inspection of the detected object. This process may involve either repositioning the existing penetrometer or deploying a new one. A mobile unit is then dispatched to either move the existing penetrometer or place a new one at the calculated location. Once in position, this penetrometer conducts a high-resolution scan, generating and receiving high-frequency seismic waves specifically focused on the area of interest. The resulting data is transmitted back to the local facility or RAF for processing, where it is integrated with existing information to create a more comprehensive and detailed survey report. This adaptive approach allows for dynamic, targeted investigation of subsurface anomalies, enhancing the system's ability to characterize and precisely locate objects such as unexploded ordnance or other significant geological features.

In one or more embodiments, the local facility is configured to receive sensor data and employ sophisticated sensor fusion techniques to merge data from multiple penetrometers, thereby improving threat detection thresholds and generating a comprehensive survey of the area. This process leverages the distributed nature of the penetrometer network to create a more accurate and detailed picture of subsurface anomalies.

For instance, when one penetrometer generates seismic waves, the sensors on multiple penetrometers (typically three or more) detect reflections. The local facility analyzes these reflections, considering factors such as the directions from which they were received, their intensity, frequency spectrum (assuming broadband seismic source energy as from the hammer), and precise arrival times. This multi-point data collection allows for advanced analysis techniques such as triangulation, distance estimation, and size estimation. For triangulation, by comparing directional data from multiple penetrometers, the system can estimate the general location of an anomaly. For distance estimation, using the local seismic velocity and precise signal reception times at each penetrometer, the system calculates distance estimates from each sensor to the anomaly. For size estimation, the reflected spectra at each penetrometer provide data for estimating the anomaly's size.

The local facility combines these analyses to generate a preliminary characterization of the detected anomaly. While individual penetrometers might simply note an echo and direction, creating an alert, the local facility performs the more complex task of data fusion. This includes combining data to estimate size and location, and potentially commanding penetrometers to reposition closer to a potential threat based on predefined rule systems (e.g., if estimated size is within a specific range, perform this action).

As the precision of reflected and refracted data increases relative to the size of the artifact, more details emerge, allowing for increasingly sophisticated analysis. This approach can provide sufficient detail to differentiate between different types of subsurface objects, such as distinguishing a 155 mm cannon shell from an 81/82 mm mortar shell, especially after a closer inspection enabled by adaptive penetrometer positioning.

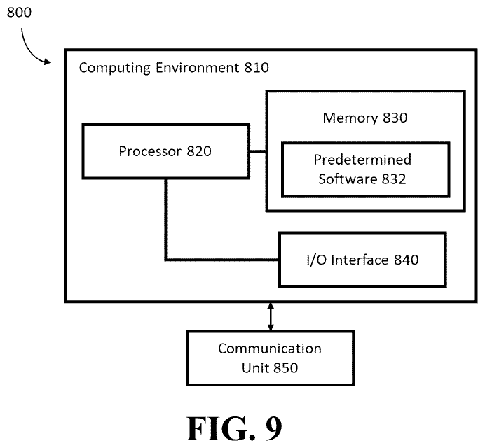

FIG. 9 shows a computing system 800 that is part of the penetrometer, local facility, RAF, and mobile unit for remote surveying. According to example embodiments shown schematically in FIG. 8, the computing system 800 includes a computing environment 810 and a communication unit 850. The computing environment 810 includes a processor 820, a memory 830, and an I/O interface 840. The computing environment 810 is coupled to the communication unit 850 through the I/O interface 840.

The processor 820 can typically control the overall operations of the computing environment 810, such as the operations associated with data acquisition, data processing, and data communications. The processor 820 can include one or more processors to execute instructions to perform all or some of the steps in the above-described methods. Moreover, the processor 820 can include one or more modules that facilitate the interaction between the processor 820 and other components. The processor may be or include a central processing unit (CPU), a microprocessor, a single chip machine, a graphical processing unit (GPU), System on a Chip (SoC), Tensor Processing Unit (TPU), Quantum Processor, Vision Processing Unit (VPU) or the like.

The memory 830 can store various types of data to support the operation of the computing environment 810. The Memory 830 can include predetermined software 831. Examples of such data comprise instructions for any applications or methods operated on the computing environment 810, financial data, user data, entity data, etc. The memory 430 may be implemented by using any type of volatile or non-volatile memory devices, or a combination thereof, such as a static random-access memory (SRAM), Dynamic Random-Access Memory (DRAM), an electrically erasable programmable read-only memory (EEPROM), an erasable programmable read-only memory (EPROM), a programmable read-only (PROM), an erasable programmable read-only memory (EPROM), a programmable read-only memory (PROM), a read-only memory (ROM), a magnetic memory, a flash memory, a magnetic or optical disk.

The I/O interface 840 can provide an interface between the processor 820 and peripheral interface modules, such as RF circuitry, external port, proximity sensor, audio and speaker circuitry, video and camera circuitry, microphone, accelerometer, display controller, optical sensor controller, intensity sensor controller, other input controllers, keyboard, a click wheel, buttons, Touchscreen Controller, Pressure Sensor, Light Emitting Diode (LED) Controller, Universal Serial Bus (USB) Controller, Serial Peripheral Interface (SPI) Bus Controller, Digital-to-Analog Converter (DAC), Analog-to-Digital Converter (ADC), Radio Frequency Identification (RFID) Reader/Writer and the like. The buttons may include but are not limited to, a home button, a power button, and volume buttons.

Communication unit 850 provides communication between the processing unit, an external device, mobile device, and a webserver (or cloud). The communication can be done through, for example, a mesh network, WIFI, or BLUETOOTH hardware protocols, Cellular Networks (4G LTE, 5G), NFC (Near Field Communication), Radio Frequency Identification (RFID), Satellite Communication, Ethernet or the like. The communication unit 860 can be within the computing environment or connected to it.

In one or more embodiments, the computing environment 810 can be coupled to a user interface that can include a speaker, lights, display, haptic feedback motor, Gesture Recognition System, Tactile Feedback Devices, Biometric Sensors, Voice Recognition System or other similar technologies for communicating with the user.

In some embodiments, there is also provided a non-transitory computer-readable storage medium comprising a plurality of programs, such as comprised in the memory 830, executable by the processor 820 in the computing environment 810, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs for execution by a computing device having one or more processors, where the plurality of programs when executed by one or more processors, cause the computing device to perform the above-described method for motion prediction.

In some embodiments, the computing environment 810 may be implemented with one or more application-specific integrated circuits (ASICs), digital signal processors (DSPs) digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures and may be rearranged as appropriate. It is therefore intended that the appended claim includes all such alterations, permutations, and equivalents as fall within the true spirit and scope of the present invention.

What is claimed is:

1. A penetrometer comprising:
a mounting interface;
a housing comprising:
a seismic wave generator configured to generate high-frequency seismic waves,
sensors capable of detecting the high-frequency seismic waves,
a control unit for controlling the seismic wave generator and processing sensor data, and
a battery for powering housing components; and
a penetrator interface configured to facilitate entry of the housing into a subsurface.

2. The penetrometer of claim 1, wherein the high-frequency seismic waves comprise any frequency up to 60,000 Hz.

3. The penetrometer of claim 1, wherein the housing further comprises sensors capable of detecting seismic/acoustic waves at any frequency up to 60,000 Hz.

4. The penetrometer of claim 1, wherein the seismic wave generator comprises an internal recoilless hammer for seismic wave generation.

5. The penetrometer of claim 4, wherein the seismic wave generator is configured to drive the housing into the subsurface.

6. The penetrometer of claim 1, further comprising an electromagnetic device for seismic wave generation oriented normal to the penetrometer centerline.

7. The penetrometer of claim 1, wherein the control unit comprises a data buffer, data transmitter, and data acquisition unit.

8. The penetrometer of claim 7, wherein the control unit is configured to coordinate seismic wave generator operation, data acquisition from the sensors, and external data transmission, enabling operation of high-resolution subsurface object detection and characterization.

9. The penetrometer of claim 1, wherein the housing further comprises a global navigation satellite system (GNSS) receiver, angle sensors, and a gyroscope for maintaining vertical orientation.

10. A system for high-frequency remote surveying comprising:
a local facility configured to map out an area for remote surveying;
at least one penetrometer comprising:
a mounting interface;
a housing comprising:
a seismic wave generator configured to generate high-frequency seismic waves,
sensors capable of detecting the high-frequency seismic waves,
a control unit for controling the seismic wave generator and processing sensor data, and
a battery for powering housing components, and
a penetrator interface configured to facilitate entry of the housing into a subsurface;
a mobile unit configured to place the at least one penetrometer within the area for remote surveying; and
a network configured to allow the local facility, at least one penetromer, and the mobile unit to communicate.

11. The system of claim 10, wherein the housing further comprises sensors capable of detecting acoustic waves at frequencies up to 60,000 Hz.

12. The system of claim 10, wherein the seismic wave generator comprises an internal recoilless hammer for seismic wave generation.

13. The system of claim 10, further comprising a local facility configured to receive sensor data and use sensor fusion techniques to merge data from multiple penetrometers to improve threat detection thresholds and generate a survey of the area.

14. The system of claim 10, wherein the local facilityis configured to receive sensor data and merge it using data fusion to identify the specific size shape, and type of underground threats and to generate a survey of the area.

15. The system of claim 10, wherein the local facility is configured to receive the high-frequency seismic wave data and identify artifacts.

16. The system of claim 10, wherein the mobile unit comprises a ground vehicle comprising a robotic arm configured to place the at least one penetromer in a predetermined location of the area being surveyed.

17. A method for remote surveying comprising:
receiving, at a mobile unit, a first location for a predetermined area to be surveyed;
placing, by the mobile unit, a first penetrometer at the first location;
activating, at the first penetrometer, a seismic wave generator configured to generate impact forces for driving the first penetrometer into a subsurface of the first location;
activating, at the first penetrometer, the seismic wave generator configured to generate high-frequency seismic waves;
receiving, at the first penetrometer, reflected and refracted high-frequency seismic waves;
transmitting high-frequency seismic wave data; and
generating a survey report of the first location based on the high-frequency seismic wave data.

18. The method of claim 17, further comprising:
receiving, at the mobile unit, a second location for a predetermined area to be surveyed;
placing, by the mobile unit, a second penetrometer at the second location; and
generating a survey report of the first location and second location based on the high-frequency seismic wave data.

19. The method of claim 17, wherein a local facility is configured to receive the high-frequency seismic wave data and generate a survey report based on the high-frequency seismic wave data.

20. The method of claim 17, further comprises:
receiving, at the mobile unit, a third location for the area to be surveyed;
retrieving, by the mobile unit, the first penetrometer at the first location; and
placing, by the mobile unit, the first penetrometer at the third location.
